(19) United States
(12) Patent Application Publication
(10) Pub. No.: US 2025/0019294 A1
(43) Pub. Date: Jan. 16, 2025

(54) LASER DEFINED RECESSES IN TRANSPARENT LAMINATE SUBSTRATES

(71) Applicant: CORNING INCORPORATED, CORNING, NY (US)

(72) Inventors: Patrick Scott Leslie, Tucson, AZ (US); Craig John Mancusi Ungaro, Corning, NY (US)

(21) Appl. No.: 18/714,246

(22) PCT Filed: Nov. 18, 2022
(86) PCT No.: PCT/US22/50409

§ 371 Date: May 29, 2024

Related U.S. Application Data
(60) Provisional application No. 63/284,215, filed on Nov. 30, 2021.

(51) Int. Cl. C03C 15/00; B32B 3/30; B32B 17/00; C03C 23/00

(52) U.S. Cl. CPC C03C 15/00; B32B 3/30; B32B 17/00; C03C 23/0025; B32B 2250/02

(57) ABSTRACT

A method of forming recesses in a glass-based laminate, the method comprising: irradiating a portion of a first clad layer of a glass laminate with a pulsed laser beam, the glass-based laminate comprising the first clad layer, the irradiating producing an irradiated portion of the first clad layer and a non-irradiated portion of the first clad layer; and etching the first clad layer with an etchant that selectively etches the irradiated portion of the first clad layer relative to the non-irradiated portion of the first clad layer and selectively etches the irradiated portion of the first clad layer relative to the core layer, wherein irradiating with a pulsed laser beam is one of (1) irradiating with a focused pulsed laser beam producing damage or other physical or chemical alteration in the first clad layer to a depth not more than the first clad layer thickness and within 0.1 to 20 μm distance from the core layer, and (2) irradiating with a quasi-non-diffracting beam having a beam path and a beam intensity along a beam path in a direction of beam propagation in the first clad layer and the core layer which intensity remains within a range of from 40 to 100 percent of maximum in the first clad layer other than within a distance from the core layer in the range of from 0 to 50 μm and remains to within a range of from 40 to 0.1 percent of maximum (low intensity portion) within the core layer.

### CROSS-REFERENCE TO RELATED APPLICATIONS

This application claims the benefit of priority under 35 U.S.C. § 119 of U.S. Provisional Application No. 63/284,215 filed Nov. 30, 2021, the content of which is incorporated herein by reference in its entirety.

### BACKGROUND

The disclosure relates generally to a method of forming recesses in a glass-based laminate substrates and more particularly to a method of forming recesses in a glass or glass-ceramic laminates by using a pulsed laser beam and an etchant.

Cavities in glass are used for a wide range of products such as microfluidics, microelectronics, vacuum glazing, optical hermetic packaging, and other applications. These cavities need to have bottom roughness that is on the nanometer scale. While selective etching methods using a focused Gaussian beam may be possible, such methods are time consuming and inefficient.

The modification of the material by the laser beam allows for dissolution to be faster in the laser-damaged region (LDR) over the bulk (undamaged glass) of the material. This allows features such as cavities to be written in glass using a laser and then etched out. However, with homogenous glasses the bottom roughness of these features tends to be on the micron or larger scale, and precision control over sidewall geometry has not been achieved.

While a masking and etch technique can help solve the bottom roughness issue, this technique produces undesirably highly angled sidewalls in resultant cavities, and the sidewall angle of the cavities can vary from on the same work piece. This is also undesirable.

No admission is made that any reference cited herein constitutes prior art. Applicant expressly reserves the right to challenge the accuracy and pertinency of any cited documents.

### SUMMARY

One embodiment of the disclosure relates to a method of forming recesses in a glass-based laminate, the method comprising:
(i) irradiating a portion of a first clad layer of the glass-based laminate with a pulsed laser beam, the laminate comprising the first clad layer having a first clad layer thickness and a first clad layer external surface and a core layer having a core layer thickness, the irradiating producing an irradiated portion of the first clad layer and a non-irradiated portion of the first clad layer; and
(ii) etching the first clad layer with an etchant that selectively etches the irradiated portion of the first clad layer relative to the non-irradiated portion of the first clad layer and selectively etches the irradiated portion of the first clad layer relative to the core layer, wherein irradiating with a pulsed laser beam is one of (1) irradiating with a focused pulsed laser beam producing damage or other physical or chemical alteration in the first clad layer to a depth not more than the first clad layer thickness and within 0.1 to 20 μm distance from the core layer, and (2) irradiating with a quasi-non-diffracting beam having a beam path and a beam intensity along a beam path in a direction of beam propagation in the first clad layer and the core layer which intensity remains within a range of from 40 to 100 percent of maximum in the first clad layer other than within a distance from the core layer in the range of from 0 to 50 μm and remains to within a range of from 40 to 0.1 percent of maximum (low intensity portion) within the core layer. According to some embodiments the core layer is either glass or glass-ceramic and/or first clad layer is either glass or glass-ceramic. Preferably, at least the first clad layer is transparent to the pulsed laser beam.

One embodiment of the disclosure relates to a method of forming recesses in a glass laminate, the method comprising:
(i) irradiating a portion of a first clad layer of a glass laminate with a pulsed laser beam, the glass laminate comprising the first clad layer having a first clad layer thickness and a first clad layer external surface and a core layer having a core layer thickness, the irradiating producing an irradiated portion of the first clad layer and a non-irradiated portion of the first clad layer; and
(ii) etching the first clad layer with an etchant that selectively etches the irradiated portion of the first clad layer relative to the non-irradiated portion of the first clad layer and selectively etches the irradiated portion of the first clad layer relative to the core layer, wherein irradiating with a pulsed laser beam is one of (1) irradiating with a focused pulsed laser beam producing damage or other physical or chemical alteration in the first clad layer to a depth not more than the first clad layer thickness and within 0.1 to 20 μm distance from the core layer, and (2) irradiating with a quasi-non-diffracting beam having a beam path and a beam intensity along a beam path in a direction of beam propagation in the first clad layer and the core layer which intensity remains within a range of from 40 to 100 percent of maximum in the first clad layer other than within a distance from the core layer in the range of from 0 to 50 μm and remains to within a range of from 40 to 0.1 percent of maximum (low intensity portion) within the core layer.

According to one embodiment, etchant selectively etches the non-irradiated portion of the first clad layer relative to the core layer with selectivity ratio within the range of from 2:1 to 100:1.

According to one embodiment, an area of a cross section of the irradiated portion, taken parallel to the first clad layer external surface beginning just inside the first clad layer external surface and progressed toward the core layer, increases at least some location along the progression.

According to one embodiment, during irradiation the pulsed laser beam is positioned relative to the glass laminate to propagate within the first clad layer at an angle within the range of from 5 to 45 degrees of normal to a surface of the first clad layer.

According to one embodiment the pulsed laser beam is a quasi-non-diffracting beam and wherein the radial energy distribution of the pulsed laser beam, while in Gaussian propagation, is limited by an aperture with an aperture radius corresponding to a beam intensity within a range of from 10 to 70 percent of peak beam intensity. According to some embodiments the aperture is a soft aperture.

According to one embodiment the pulsed laser beam is a quasi-non-diffracting beam and wherein irradiating with a pulsed laser beam comprises propagating the quasi-non-diffracting beam in the first clad layer in a direction toward the core layer. According to another embodiment the pulsed laser beam is a quasi-non-diffracting beam and wherein irradiating with a pulsed laser beam comprises propagating the quasi-non-diffracting beam in the first clad layer in a direction away from the core layer.

According to one embodiment the glass laminate comprises a second clad layer opposite the first clad layer with the core layer between the first clad layer and the second clad layer, and wherein the method comprises irradiating a portion of the second clad layer and etching the second clad layer.

According to one embodiment the pulsed laser beam is a quasi-non-diffracting beam having a focal spot and/or focal ring width along the beam path in a direction of beam propagation which increases by an increase in the range of from 1 to 400 percent per 100 μm distance in the downstream direction.

According to one embodiment the pulsed laser beam is a quasi-non-diffracting beam having a focal spot and/or focal ring width along the beam path in a direction of beam propagation which decreases by in the range of from 1 to 80 percent per 100 μm distance in the downstream direction.

According to one embodiment the pulsed laser beam is a quasi-non-diffracting beam and the beam path of the quasi-non-diffracting beam is curved at least in part.

According to one embodiment the pulsed laser beam is an annular quasi-non-diffracting beam.

According to one embodiment the pulsed laser beam is an annular quasi-non-diffracting beam having a varying radius.

According to one embodiment the pulsed laser beam is an Airy beam.

According to one embodiment the pulsed laser beam is a quasi-non-diffracting beam and wherein the average width of the quasi-non-diffracting beam within the first clad layer is in the range of from 50 μm to 300 μm.

According to one embodiment the pulsed laser beam is a quasi-non-diffracting beam transmitted or formed at least in part by an adaptive optical element.

According to one embodiment irradiating a portion of the first clad layer of a glass laminate with a pulsed laser beam comprises varying the properties of the adaptive optical element to vary one or more properties of the quasi-non-diffracting beam.

According to one embodiment, a glass-based laminate comprises:
(i) a glass-based core layer; and
(ii) at least one cladding situated directly adjacent to the core layer, the at least one clad layer comprising at least one recess with at least one vertical sidewall and a smooth bottom with RMS surface roughness of ≤75 nm, and preferably ≤50 nm, for example 5 nm to 50 nm, or 20 nm to 50 nm. According to some embodiments the clad layer is transparent to at least one wavelength between 200 nm and 2000 nm, for example, to 1064 nm, 1030 nm, 532 nm, 530 nm, 355 nm, or 266 nm. According to some embodiments the clad layer is glass or glass ceramic. According to some embodiments the clad layer is glass or glass-ceramic transparent to at least one wavelength between 200 nm and 2000 nm. In the exemplary embodiments disclosed herein the core layer is fused to the at least one clad layer(s).

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings illustrate one or more embodiment(s), and together with the description serve-to-explain principles and operation of the various embodiments. [If there are no appended drawings, amend accordingly.]

### BRIEF DESCRIPTION OF THE DRAWINGS

FIG. 1 schematically depicts an example glass laminate having a plurality of recesses formed in accordance of one or more embodiment described herein;

FIG. 2A is a side view of Laser damaged regions (LDRs) formed in a clad layer of an example glass-based laminate;

FIG. 2B is a top view of LDRs formed in a clad layer of the example glass-based laminate shown in FIG. 2A;

FIG. 3A schematically depicts an example optical system to produce laser damaged regions according to one or more embodiment described herein;

FIG. 3B schematically depicts an example optical system to produce laser damaged regions according another embodiment described herein;

FIGS. 4A-4C illustrate three different embodiments of phase masks for a special light modulator (SLD) utilized in some embodiments of the optical system embodiment of FIG. 3B;

FIG. 5A graphically depicts an example of Gauss-Bessel laser beam intensity profile along an optical axis according to one or more embodiments described and illustrated herein;

FIG. 5B graphically depicts an example of top-hat laser beam intensity profile along an optical axis according to one or more embodiment described and illustrated herein;

FIG. 6 illustrates aperture position for one or more embodiments that reduce the length of the focal line incident on the glass-based laminate;

FIG. 7A illustrates axial intensities of Bessel beams produced by an optical systems with and without apertures situated in the path of the Gaussian laser beam incident on the optical system;

FIG. 7B illustrates a correct exemplary placement of the glass laminate relative to the Bessel beam produced by an optical system of FIG. 3A that does not have an aperture in the path of the Gaussian laser beam incident on the optical system;

FIG. 7C illustrates a correct exemplary placement of the glass laminate relative to the Bessel beam produced by an optical system of FIG. 3A that has the aperture placed in the path of the Gaussian laser beam incident on the optical system;

FIG. 8 depicts etched down LDR area situated within the cladding layer;

FIG. 9A depicts a recess with a smooth bottom according to one embodiment disclosed herein,

FIG. 9B depicts a comparative cavity with a rough bottom produced by laser-enhanced etching in non-laminate glass;

FIG. 10 depicts Zygo imaging system's roughness measurement of the recess bottom shown in FIG. 9A;

FIG. 11 illustrates sidewall's tilt angle as well as the smooth bottom of the recess formed after the etching the laser damaged region area formed by a Bessel beam that has beam propagation axis situated normal to the laminate's surface;

FIG. 12 illustrates schematically a recess with an angled sidewall produced by a typical (not-angled Bessel beam) that is incident at a normal angle to the laminate's surface, as well as the Bessel beam incident angle required to produce a recess with vertical sidewalls under the same etching conditions;

FIG. 13 illustrates LDRs a cladding of a glass-based laminate produced in with an angled Bessel beams;

FIG. 14 illustrates an embodiment of etched vertical sidewall produced in the cladding of the laminate after etching the LDRs area shown FIG. 13;

FIG. 15 illustrates schematically laser damage in glass formed by an angled Vortex laser beam (laser beam that has a shape of angled hollow cylinder(s);

FIG. 16 illustrates schematically laser beam induced damage in glass from use of a Funnel laser beam.

FIGS. 17A and 17B illustrate an embodiment of laser induced damage by use non-diffracting beams produced by an optical system in conjunction with different size apertures to create a desired damage angle, to create angled laser induced damaged areas by use of multiple LDRs with different lengths, in order to produce predetermined sidewall angles.

### DETAILED DESCRIPTION

The embodiments of the methods described herein can be utilized to produce one or more geometrically controlled recesses in glass-glass laminates, glass-ceramic laminates, and other transparent glass-based laminate substrates using a non-diffracting or quasi-non-diffracting ultrafast laser beam(s).

Laser damaged regions (LDRs) formed within a single glass layer substrate may be filled by an electroplating process wherein electrically conductive material (e.g., copper) is coated on the interior surfaces of the LDRs, or may be filled with other materials or miniature components (e.g., microcircuits). However, roughness on the bottom of the laser damaged regions (LDRs) in single layer glass (for example caused by the microcracks and/or voids) may lead to non-uniform metal coatings, or improper adhesion of miniature components to the bottom of the LDRs, which may result in inadequate electrical conductivity or mechanical reliability issues.

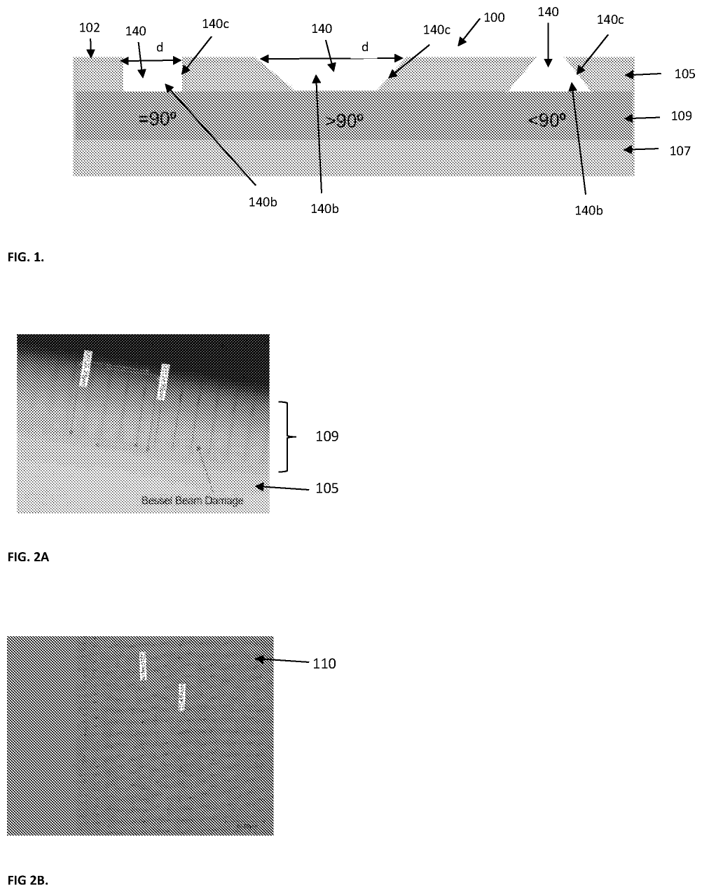

This disclosure discusses a method to create geometrically-controlled recesses (e.g., cavities with different wall angles and/or geometries) in glass-based laminates (i.e., laminates comprising at least one glass or glass-ceramic layer and at least one other layer), for example, transparent laminate substrates made from multiple fused glass layers, substrates comprising glass or glass-ceramic layers, or other transparent laminate substrates comprising glass and/or glass ceramic layers fused to one another. The recesses in glass or transparent glass-ceramics can be used for a variety of applications in microfluidics, microelectronics, packaging, and various other applications requiring the creation of at least one recess in a workpiece. These recesses have their dimensions and geometry defined by both the laser processes and the laminate glass used as the substrate. The embodiments described herein create these features by using a laminate glass or glass-ceramic substrate with an etch stop core layer and the variety of laser damage methods and/or laser beams to create recesses such as cavities, trenches or grooves with unique geometrical features. FIG. 1 illustrates several exemplary cavity geometries that can be manufactured using these approaches. Multiple cavities, trenches, or grooves with different geometries can be made in a single substrate, or one recess with different sidewall angles.

The embodiments described herein may suppress the formation of microcracks and/or voids during the laser damage process by use a laminate glass in conjunction with an etchant material applied to laser damaged regions (LDRs) 110. When the etchant material is applied to the laser damaged regions (LDRs) 110, the resultant cavities, trenches, and grooves are shown to have fewer microcracks and/or voids than the LDRs formed within the glass laminates without an etchant material. Thus, after the chemically etching, the resulting recesses (cavities, trenches, or grooves) have a smoother bottom surface than LDRs formed by a laser process that does not employ an etchant material in conjunction with using a glass laminate, such as, for example a glass “etch resistant” core layer, described below.

In some embodiments, pulsed, quasi-non-diffracting laser beams are applied through a substrate to form the one or more laser damaged regions (LDR) 110 through a glass laminate substrate 100 with a pulsed laser. An etching solution is then applied to the glass laminate to open up the one or more laser damaged regions (LDR) 110 into one or more recess(es) 140 that have smooth bottoms 140b, and walls 140c that have the desired geometry (e.g., vertical walls). A glass laminate comprises, for example, a glass core layer 109 fused to one or more glass clad layers 105, 107.

According to the exemplary embodiments described herein, the clad layer(s) 105, 107 and the core layer 107 are made of different materials, with the core layer 109 more resistant to etching, such that clad layer 105, 107 etches at a faster rate than the core layer, the core layer being “etch resistant” and/or functioning as an “etch stop”, with the material of the glass core 109 forming smooth bottoms 140b.

These recesses 140 may be etched from a laser damaged region (LDR) concentrated in the clad layer of a laminate that has a glass layer with “Etch Stop” properties. The etch stop property is due to differences in the glasses' clad and core dissolution rates where the clad's material etch rate is faster than the core's etch rate. The laser damage used for these applications can be controlled to block any unwanted damage from entering the core of the substrate. After laser damage, the substrate is etched down to the etch stop core in the modified material region and a recess 140 (e.g., a cavity) is produced. The slow etching rate in the core (as the clad) prevents the core region from being etched quickly, which results in an optically smooth cavity's bottom.

Control over sidewall geometry (or wall angles) can be achieved by altering the side wall shape of the LDRs. If the LDR is a cube shape with vertical walls, then the resulting recess will have angled sidewalls due to the etching process. The angle of the sidewall(s) can be changed by changing the shape of the LDR.

One embodiment of the disclosure relates to a method of forming recesses 140 in a glass-based laminate substrate 100, the method comprising:
(i) irradiating a portion of a first clad layer 105 or 107 of a glass based laminate with a pulsed laser beam, the glass-based laminate comprising the first clad layer having a first clad layer thickness and a first clad layer external surface and a core layer 109 having a core layer thickness, the irradiating producing an irradiated portion of the first clad layer and a non-irradiated portion of the first clad layer; and
(ii) etching the first clad layer with an etchant that selectively etches the irradiated portion of the first clad layer relative to the non-irradiated portion of the first clad layer and selectively etches the irradiated portion of the first clad layer relative to the core layer, wherein irradiating with a pulsed laser beam is one of (1) irradiating with a focused pulsed laser beam producing damage or other physical or chemical alteration in the first clad layer to a depth not more than the first clad layer thickness and within 0.1 to 20 μm distance from the core layer, and (2) irradiating with a quasi-non-diffracting beam having a beam path and a beam intensity along a beam path in a direction of beam propagation in the first clad layer and the core layer which intensity remains within a range of from 40 to 100 percent of maximum in the first clad layer other than within a distance from the core layer in the range of from 0 to 50 μm and remains to within a range of from 40 to 0.1 percent of maximum (low intensity portion) within the core layer.

According to one embodiment, the etchant selectively etches the non-irradiated portion of the first clad layer 105 or 107 relative to the core layer 109 with selectivity ratio within the range of from 2:1 to 100:1.

In some embodiments, the upper clad layer 105 and/or the lower clad layer 107 etch at least 2 times faster, at least 5 times faster, at least 10 times faster, at least 20 times faster, at least 50 times faster, or at least 100 faster than the glass central core layer 109. Additionally, or alternatively, the ratio of the etch rate of the upper glass clad layer and/or the lower glass clad layer to the etch rate of the glass core layer 109 is about 5, about 15, about 20, about 25, about 30, about 35, about 40, about 45, about 50, about 60, about 65, about 70, about 75, about 80, about 85, about 95, about 100, or any range defined by any combination of the stated values.

The etching of the clad layer(s) with an etchant that selectively etches the laser irradiated portion of the clad layer(s) relative to the non-irradiated portion of the clad layer(s) 105, 107 and selectively etches the irradiated portion of the clad layer(s) relative to the core layer 109. In some embodiments, the process for forming cavities, trenches, or grooves (referred collectively to as recesses 140 herein) comprises etching substantially entirely through the thickness of the upper clad layer 105 and/or the lower clad layer 107, to expose a portion of the core layer 109 at the bottom of the recesses 140. Thus, the sidewalls 140c of the recesses 140 are defined by the upper glass clad layer 105 and/or by the lower clad layer 107, and the floors (or bottoms) 140b of the recesses 140 are defined by the core layer 110. In some embodiments, the glass core 109 is not substantially etched during formation of the cavities 140. The glass core 109 serves as an etch stop that determines the depth of the recesses 140.

In some embodiments, the glass laminate's layers may be fabricated from any material that is transparent to at least one wavelength of a laser beam used to form the at least one laser damaged region (LDR) 110. As used herein, “transparent” means that the material has an optical loss, such as absorption or scattering, of less than about 20% per mm of material depth, such as less than about 10% per mm of material depth for the specified pulsed laser wavelength, or such as less than about 1% per mm of material depth for the specified pulsed laser wavelength. The absorption of the glass laminate substrate may be measured using a spectrophotometer, such as a Cary 5000 sold by Agilent Technologies of Santa Clara, Calif. Example glass laminate materials include, but are not limited to borosilicate glass, soda-lime glass, aluminosilicate glass, alkali aluminosilicate glass, alkaline earth aluminosilicate glass, alkaline earth boro-aluminosilicate glass, fused silica, crystalline materials such as sapphire, silicon, gallium arsenide, glass-ceramic, or silicon materials or combinations thereof.

By using angled non-diffractive beams (e.g., angled Bessel beams), we can create an LDR 110 that has angled sidewalls. If the correct angle is chosen for the LDR sidewall, then the resulting etched recess will have a vertical sidewall. According to some embodiments, during irradiation the pulsed laser beam is positioned relative to the laminate substrate 100 to propagate within the first clad layer (e.g., top clad layer 105) at an angle with the range of from 5 to 45 degrees of normal to a surface of the first clad layer.

For example, an ultrafast laser is chosen which operates at a wavelength which the glass laminate or the clad layer of the glass laminate is transparent to. This allows the unfocused laser light to pass through the glass without being absorbed; however, when the light is focused and reaches a high intensity, nonlinear absorption will occur. Non-diffracting beams have focal lines that do not vary much as they travel along the laser propagation direction. Because of this, the focal lines can uniformly penetrate through the entire thickness of a laminate glass substrate, and thus damage the entire thickness of a laminate glass substrate with a single pulse. To prevent this from happening, we shorten the focal line formed by the optical system using aperture(s) 129, so that the focal line damages only the clad layer of the glass laminate substrate and not the core layer 109.

According to some embodiments the pulsed laser beam is a quasi-non diffracting beam and wherein the radial energy distribution of the pulsed laser beam, while in Gaussian propagation, is limited by an aperture 129 having at an aperture radius corresponding to a beam intensity within a range of from 10 to 70 percent of peak (maximum) laser beam intensity.

According to one embodiment the pulsed laser beam is a quasi-non-diffracting beam and irradiating with a pulsed laser beam comprises propagating the quasi-non-diffracting beam in the first clad layer in a direction toward the core layer 109. According to another embodiment the pulsed laser beam is a quasi-non-diffracting beam and irradiating with a pulsed laser beam comprises propagating the quasi-non-diffracting beam in the first clad layer in a direction away from the core layer 109.

According to one embodiment the glass laminate comprises a second clad layer opposite the first clad layer with the core layer 109 between the first clad layer and the second clad layer, and wherein the method comprises irradiating a portion of the second clad layer and etching the second clad layer.

According to one embodiment the pulsed laser beam is a quasi-non-diffracting beam having a focal spot and/or focal ring width along the beam path in a direction of beam propagation which increases by an increase in the range of from 1 to 400 percent per 100 μm distance in the downstream direction.

According to one embodiment the pulsed laser beam is a quasi-non-diffracting beam having a focal spot and/or focal ring width along the beam path in a direction of beam propagation which decreases by in the range of from 1 to 80 percent per 100 μm distance in the downstream direction.

According to one embodiment the pulsed laser beam is a quasi-non-diffracting beam and the beam path of the quasi-non-diffracting beam is curved at least in part.

According to one embodiment the pulsed laser beam is an annular quasi-non-diffracting beam.

According to one embodiment the pulsed laser beam is an annular quasi-non-diffracting beam having a varying radius.

According to one embodiment the pulsed laser beam is an Airy beam.

According to one embodiment the pulsed laser beam is a quasi-non-diffracting beam wherein the average width of the quasi-non-diffracting beam within the first clad layer is in the range of from 50 to 300 μm.

According to one embodiment the pulsed laser beam is a quasi-non-diffracting beam transmitted or formed at least in part by an adaptive optical element.

According to one embodiment irradiating a portion of the first clad layer of a glass laminate or a glass-ceramic laminate with a pulsed laser beam comprises varying the properties of the adaptive optical element to vary one or more properties of the quasi-non-diffracting beam.

The non-diffracting laser beams that can be utilized in the embodiments of the process disclosed herein include Bessel Beams, angled Bessel Beams, curving Bessel Beams, Airy Beams, Vortex Beams, Funnel Beams, Vari Rad Beams and other modified beams made with physical/fixed or dynamic optics. Each of these laser beams can be used to add a unique feature for different geometrically-shaped cavities. The laser damage of the glass laminate substrate 100 is preferably only done in the clad layer(s) of the glass laminate 100. For example, a Bessel beam has a long, thin cylindrical focal region and can be used to create cubic-shaped LDRs 110 with right angle sidewalls (the sidewalls of the resulting recess will have an angle after etching).

Angled Bessel beams are Bessel beams that have been compensated for aberrations due to refraction when entering a glass workpiece (e.g., glass-based laminate substrate 100) at an angle that is not normal to the top surface of the glass laminate substrate. This compensation allows them to retain their non-diffracting nature when propagating at a non-normal angle inside the glass laminate substrate. Angled Bessel beams can be utilized to create LDRs 110 with angled sidewalls. This can result in a recess 140 with a specific, predetermined sidewall angle, depending on the incident angle of the Bessel beam. Use of specific non-normal incident angles, followed by the etching step described herein can create recesses 140 with vertical sidewalls 140c.

Caustic beams such as Airy and curving Bessel beams are non-diffracting beams whose focal regions follow a curved path as they propagate. Airy beams typically follow a parabolic profile while curving Bessel beams can be made to follow an arbitrary profile (within limits imposed by lens NA and diffraction). These beams can be used to make recesses (e.g., trenches or cavities) with curved or snaking sidewall profiles.

Hollow core laser beams such as Vortex, Funnel, and Vari Rad beams are laser beams whose focal regions are in a form of long, hollow tubes. Vortex beam tubes can have straight sidewall cross-sections, while Funnel and Vari Rad beams have angled or curving sidewall cross-sections, respectively. Hollow core beams can be used to decrease etching and laser processing time, compared to the damage created by using Bessel beams. Funnel and Vari Rad beams can also be used to control sidewall geometry of the recesses 140.

In some of the embodiments described herein LDRs 110 (illustrated in FIG. 2A) were produced by utilizing a Lumentum Picoblade 2 (1064 nm) laser and a Light Conversion Pharos (1030 nm) laser. Both of these lasers provide near-IR wavelengths. According to at least some embodiments, these lasers were used to create both burst mode damage in glass clad layers of the laminate(s) 100 with up to 1 mJ total energy and high pulse energy damage with up to 2 mJ/pulse.

Burst mode lasers refer to lasers where a train pulses can be emitted at a frequency much higher than the operating repetition rate. Typically, this means delays between pulses within each burst of a few nanoseconds. In the embodiments utilizing the Lumentum Picoblade 2 laser, there is a delay of 12.5 ns between each of multiple pulses within each pulse burst.

Other lasers may also be utilized. For example, the wavelength of the laser may be 532 nm, the pulse width about 7 psec, and a 20 nsec time between each pulse within the burst.

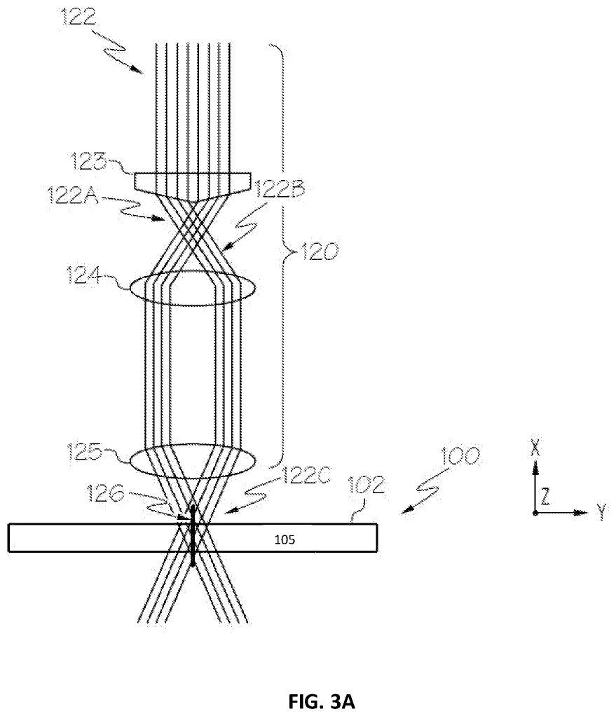

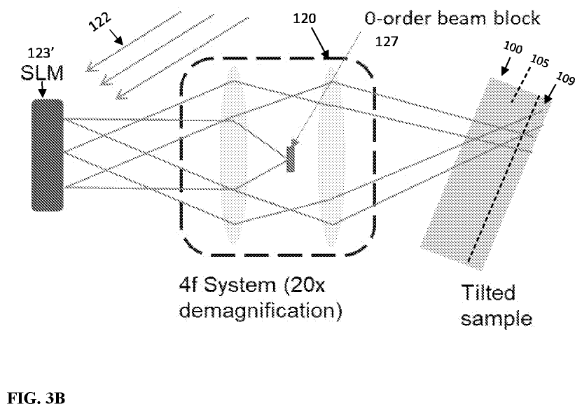

When creating a recess in a substrate, the laser must be scanned in the X and Y directions across the entire area of the recess. A Z-direction scan isn't necessary due to the use of non-diffracting or quasi-non-diffracting beams. The pitch in the X and Y directions must be low enough to allow the whole area to be etched; however, lowering the pitch increases the processing time required. With a single pulse laser (instead of having multiple pulses per burst), a pitch of 1-5 μm would be necessary when using the optical system of FIG. 3A. In contrast, when using a burst-pulse laser that provides 3 pulses in the burst) we were able to use a pitch of 10-15 μm. Higher burst numbers reduce the pitch further, but too many pulses per burst can lead to increased roughness of the recess sidewall(s) 140b. Accordingly, it is preferable that the number of pulses per burst be 25 or less, for example 20 or less, e.g., 3 to 20, or 3 to 15 pulses per burst.

Some embodiments of methods for forming holes in substrates are described in detail below.

Referring again to FIG. 1, an example glass laminate substrate 100 having a plurality of recesses 140 formed therein is schematically illustrated. The glass laminate substrate 100 may be fabricated from any suitable materials that are transparent to at least one wavelength of a laser beam used to form the Laser damaged regions (LDRs) 110 as described in more detail below and shown, for example in FIGS. 2A and 2B. More specifically, FIG. 2A is a side view of laser damaged regions (LDRs) 110 formed in a clad layer 105 of an example glass laminate 100. FIG. 2B is a top view of LDRs 110 formed in a clad layer 105 of the example glass laminate 100 shown in FIG. 2A. The glass laminate substrate 100 may have any suitable thickness t depending on the end-application, including, but not limited to 0.05 mm to 10 mm, including endpoints. In some embodiments, the thickness of the glass laminate substrate 100 is within a range of 0.1 mm to 0.7 mm, including endpoints. The laser damaged regions (LDRs) 110 are formed within a bulk of the glass laminate substrate 100 between an entrance surface 102 (i.e., a first surface) of the clad layer and another surface situated at. or adjacent to the interface between the clad layer and the core layer 109 of the glass laminate). LDRs 110 are regions formed within a bulk of the cladding material of the laminate substrate 100, where the glass material that is modified by laser-induced multi-photon absorption, as described in more detail below. As shown in FIGS. 2A and 2B, the LDR(s) 110 may be a narrow hole that extends through the clad layer 105 of the glass laminate substrate 100, and/or may be a non-continuous channel that is interrupted by the material of glass laminate substrate 100, as shown for example in FIG. 2B.

It is noted that after the LDRs 110 are formed, and after subsequent etching of the LDRs, the resultant recesses 140 will be disposed in the clad layer of the glass-based laminate substrate 100 (e.g., within the clad layer of the glass-glass laminate) as depicted, for example, in FIG. 1. The LDRs 110 are formed by application of a quasi-non-diffracting laser beam within the glass laminate 100, as described in detail below and schematically illustrated in FIGS. 3A and 3B.

After the LDRs 110 are formed, the glass laminate substrate 100 is then subjected to a chemical etchant. Etchants are not limited by the present disclosure. Typical etchants that may be used include, but are not limited to hydrogen fluoride acid mixtures, and also basic solutions such as potassium hydroxide and sodium hydroxide. For example, an etchant may be a 1.45M hydrofluoric and 1.58M nitric etchant solution. The LDRs 110 are regions within the bulk of the substrate 100 (e.g., within clad layer(s) 105, 107) that have been damaged by the laser beam. The etch rate of LDRs 110 is greater than the etch rate of non-damaged regions of the clad layer(s) of the substrate 100. The increased etch rate of the clad layer in the area with LDRs 110 allows recesses 140 to open up at the locations of LDRs 110 during etching, which results in formation of recesses 140 shown schematically in FIG. 1. Recesses 140 formed by the laser-damage-and-etch techniques described herein may have different shapes (different wall angles shapes), and may have a bottom diameter/width that is either equal, or smaller, or larger than the diameter/width of the recess at the entrance surface 102. As an example and not a limitation, the diameter/width d of the openings of the recesses 140 at the entrance surface 102 may be between 1 μm and 150 μm. However, other hole-opening diameters may be formed. Example laser and etching conditions to form damage regions or tracks and resulting holes in the substrates are described in U.S. Pat. No. 9,517,963, which is hereby incorporated by reference in its entirety.

FIG. 3A schematically illustrates an example optical system 120 used to form a pulsed quasi-non-diffracting beam 122C through the glass laminate substrate 100 to form one or more LDRs 110. The quasi-non-diffracting beam 122C may form a focal line 126 through the substrate 100. Directing the pulsed quasi-non-diffracting beam 122C into the substrate 100 generates an induced absorption within the substrate 100 and deposits enough energy to break chemical bonds in the substrate 100 to form the LDRs 110. The optical system 120 may include any optical components capable of producing the quasi-non-diffracting beams 122C described herein.

In the embodiment illustrated by FIG. 3A, the optical system 120 includes an axicon 123 (i.e., a conical lens), a collimating lens 124, and a focusing lens 125. A pulsed laser beam 122 from a laser source (not shown) passes through the axicon 123, which creates a primary quasi-non-diffracting beam 122A of the pulsed laser beam 122. The primary quasi-non-diffracting beam 122A diverges to form a ring beam 122B that is received by the collimating lens 124. The collimating lens 124 and the focusing lens 125 act as a telescope that relays and de-magnifies the primary quasi-non-diffracting beam 122A such that an imaged quasi-non-diffracting beam 122C is provided to the glass laminate substrate 100. The imaged quasi-non-diffracting beam 122C provides a beam spot on the entrance surface (i.e., the entrance surface 102) of the glass laminate substrate 100. The “telescope” lens configuration shown in FIG. 3A may be employed because it projects the primary quasi-non-diffracting beam 122A to a comfortable working distance away from the optical surfaces of the optical system 120, and also allows for the ability to more easily control the size of the focal line 126 defined by the quasi-non-diffracting beam 122C.

In the embodiment illustrated by FIG. 3B, the optical system 120 includes a spatial light modulator SLM 123′, a focusing lens 124, another focusing lens 125, and a zero order beam blocker 127 situated between lenses 124 and 125. A spatial light modulator (SLM) is a device that imposes some form of spatially varying modulation on an incident beam of light. The SLM can take the place of an axicon, or a combination of axicon with other optical components in an optical system. It comprises pixels similar to that of an LCD computer screen (e.g., 800×600 pixels). The gaussian laser beam provided by a laser source is reflected off the back plate of the SLM and will pass twice through each corresponding pixel. As the light passes twice through an individual pixel, the SLM 123′ can delay it from 0 to 1 wavelength, resulting in a phase shift from 0 to 2π. The applied phase shift can be independently controlled at each pixel.

A phase mask is applied to the SLM to determine how much to delay the light at each pixel. The phase mask will be, for example, an 800×600 black and white image. A phase shift of 0 is applied for a black pixel in the image, 2π for a white pixel, and somewhere in between for a grey pixel.

The SLM 123′ functions similarly to a diffractive optical component (DOE). The efficiency of the optical system 120 will be dependent on the SLM's resolution and the magnitude of the phase change between adjacent pixels in the mask. The desired image will be the 1st diffractive order. Extra light will be contained in the 0^{th} and 2^{nd} or higher orders. This extra light will frequently be blocked by a beam block (0-order beam blocker) 127 placed in the phase-space of a Fourier-transforming lens (focusing lens 124). The 0-order will be in the center of the image, while higher orders will be arranged around the center.

The two lenses 124, 125 of optical system 120 of FIG. 3B form a 4f telescope (the two lenses are placed in a double Fourier-transforming 2f configuration). This allows for demagnification of the beam by altering the length of each lens and also provides a convenient spot for placement of the beam block.

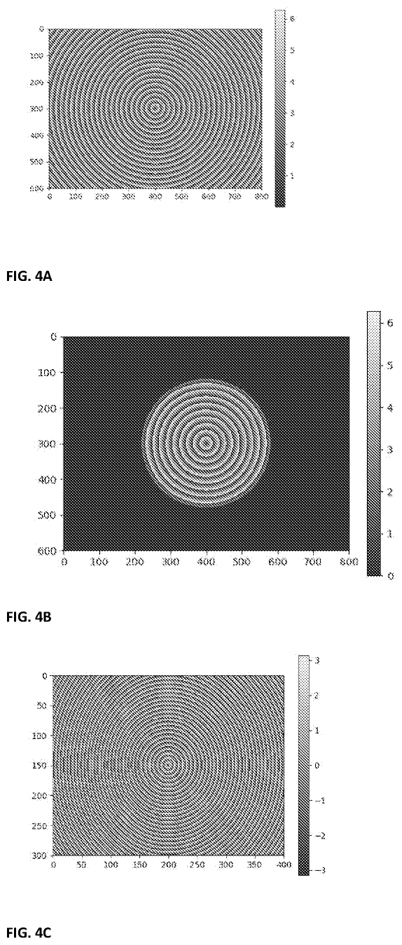

FIGS. 4A-4C illustrate three different exemplary embodiments of the phase masks for the SLM 123′. FIG. 4A illustrates a phase mask that creates a laser beam similar to the one provided by an axicon creating a normal Bessel beam (X and Y axes are pixels and the colorbar is the phase shift from 0 to 2π). FIG. 4B illustrates a phase mask that creates a laser beam similar to the one provided by an aperture 129 and axicon 123 creating a normal Bessel beam (X and Y axes are pixels and the color bar is phase shift from 0 to 2pi) shown in FIG. 3C. FIG. 4C illustrates a phase mask that creates an aberration corrected angled Bessel beam.

More specifically, the phase mask for the SLM of FIG. 3B is illustrated in FIG. 4B. In the embodiment of FIG. 3B, the SLM is taking the place of the combination of an axicon (or modified axicon) and aperture. To create an aperture function, a section of the SLM 123′ is simply left blank.

As a non-limiting example, the pulsed laser beam 122 may have a wavelength within the range from 200 nm to 2000 nm, including endpoints, for example, without limitation, 1064 nm, 1030 nm, 532 nm, 530 nm, 355 nm, or 266 nm. The laser source is operated to produce a burst of a plurality of pulses having a pulse width. In some exemplary embodiments described herein, each burst includes twenty pulses. However, it should be understood that more or fewer pulses may be provided per burst. The pulse width of the pulses may be within a range of 100 fsec to 10 psec, including endpoints.

The pulsed laser beam can have an average laser burst energy measured, at the laminate substrate 100, greater than 40 uJ per mm thickness of the substrate. The average laser burst energy used can be as high as 2500 uJ per mm of thickness of laminate substrate 100, for example 100-2000 μJ/mm, 200-1750 μJ/mm, or 500-1500 μJ/mm. This average laser energy can also be referred to as an average, per-burst, linear energy density, or an average energy per laser burst per mm thickness of the laminate substrate. Additional laser parameters to form damage tracks (LDRs) within substrates to create etched holes are described in U.S. Pat. No. 9,517,963.

The cross sectional profile of an example quasi-non-diffracting beam 122C can be described by a Bessel function, hence such laser beams are frequently referred to as Bessel beams. In a non-limiting example, the quasi-non-diffracting beam has a wavelength of about 532 nm and a numerical aperture of about 0.29, which provides a core at the center of the Bessel beam focal line having a diameter of about 1.2 μm. The intensity of the laser beam in this core spot can be maintained over lengths of hundreds of microns, which is much longer than the diffraction limited Rayleigh range of a typical Gaussian profile beam of equivalent spot size (i.e., only a few microns).

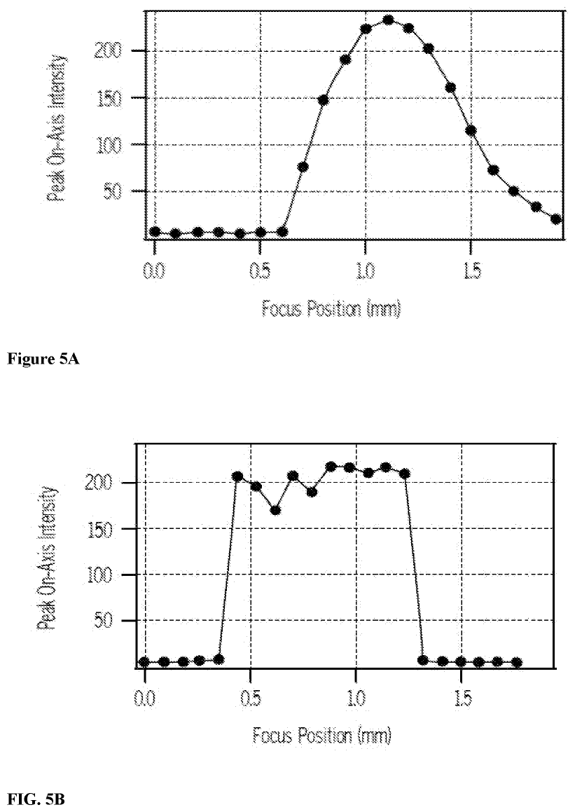

Such an optical system 120 as shown in FIG. 3A can be thought of as mapping the radial (i.e., lateral) intensity distribution of the input pulsed laser beam 122 to an intensity distribution along the optical axis to form a focal line. With a typical Gaussian beam from a laser illuminating this optical system 120, the beam intensity along the optical axis will take the form as shown in FIG. 5A. The length of the focal line that is produced is proportional to the diameter of the pulsed laser beam 122 sent into the axicon 123. Such a quasi-non-diffracting beam is known as a Gauss-Bessel beam.

A non-diffracting or quasi-non-diffractive laser beam can also be created using an optical system that includes dynamic optical component(s), for example a spatial light modulator (SLM). Such an optical system preferably utilizes a physical or dynamic aperture 129 to shorten the focal line of the laser beam to protect the core 109 of the glass laminate substrate 100.

It is noted that the pulsed laser beam 122 used to illuminate the optical system 120 need not have a Gaussian profile, and additionally one need not use an axicon 123 to form the quasi-non-diffracting beam 122C. Thus, it is possible to form different energy distributions along the optical axis, where the intensity may take the form of a “top hat” profile, or other profile shape. As shown in FIG. 5B, a “top hat” beam intensity profile provides the ability to more uniformly distribute the beam energy through the required depth of the substrate 100, or to tailor the energy distribution so that certain regions of the substrate 100 receive more or less energy than others in a deterministic manner. The creation of such optics is described in U.S. Patent Publication US 2018-0062342, which is incorporated by reference herein in its entirety.

As stated above, the length of the quasi-non-diffracting beam 122C is determined by its Rayleigh range. Particularly, the quasi-non-diffracting beam 122C defines a laser beam focal line 126 having a first end point and a second end point each defined by locations where the quasi-non-diffracting beam has propagated a distance from the beam waist equal to a Rayleigh range of the quasi-non-diffracting beam. A detailed description of the formation of quasi-non-diffracting beams and determination of their lengths, including a generalization of the description of such beams to asymmetric (such as non-axisymmetric) beam cross sectional profiles, is provided in U.S. patent application Ser. No. 15/718,848 and Dutch Patent Application No. 2017998, which are incorporated by reference in their entireties.

The Rayleigh range corresponds to the distance (relative to the position of the beam waist as defined in Section 3.12 of ISO 11146-1:2005 (E)) over which the variance of the laser beam doubles (relative to the variance at the position of the beam waist) and is a measure of the divergence of the cross sectional area of the laser beam. The Rayleigh range can also be observed as the distance along the beam axis at which the peak optical intensity observed in a cross sectional profile of the beam decays to one half of its value observed in a cross sectional profile of the beam at the beam waist location (location of maximum intensity). The quasi-non-diffracting beam defines a laser beam focal line having a first end point and a second end point. The first and second end points of a quasi-non-diffracting beam are defined as the locations where the quasi-non-diffracting beam has propagated a distance from the beam waist equal to the Rayleigh range of the quasi-non-diffracting beam. Laser beams with large Rayleigh ranges have low divergence and expand more slowly with distance in the beam propagation direction than laser beams with small Rayleigh ranges.

Beam cross section is characterized by shape and dimensions. The dimensions of the beam cross section are characterized by the spot size of the beam. For a Gaussian beam, spot size is frequently defined as the radial extent at which the intensity of the beam decreases to 1/e² of its maximum value. The maximum intensity of a Gaussian beam occurs at the center (x=0 and y=0 (Cartesian) or r=0 (cylindrical)) of the intensity distribution and radial extent used to determine spot size is measured relative to the center.

Beams with Gaussian intensity profiles may be less preferred for laser processing to form damage tracks 110 because, when focused to small enough spot sizes (such as spot sizes in the range of microns, such as about 1-5 μm or about 1-10 μm) to enable available laser pulse energies to modify materials such as glass, they are highly diffracting and diverge significantly over short propagation distances. To achieve low divergence, it is desirable to control or optimize the intensity distribution of the pulsed laser beam to reduce diffraction. Pulsed laser beams may be non-diffracting or weakly diffracting. Weakly diffracting laser beams include quasi-non-diffracting laser beams. Representative weakly diffracting laser beams include Bessel beams, Gauss-Bessel beams, Airy beams, Weber beams, and Mathieu beams.

Non-diffracting or quasi-non-diffracting beams generally have complicated intensity profiles, such as those that decrease non-monotonically vs. radius. By analogy to a Gaussian beam, an effective spot size w_{o,eff} can be defined for any beam, even non-axisymmetric beams, as the shortest radial distance, in any direction, from the radial position of the maximum intensity (r=0) at which the intensity decreases to 1/e² of the maximum intensity. Further, for axisymmetric beams w_{o,eff} is the radial distance from the radial position of the maximum intensity (r=0) at which the intensity decreases to 1/e² of the maximum intensity. A criterion for Rayleigh range based on the effective spot size w_{o,eff} for axisymmetric beams can be specified as non-diffracting or quasi-non-diffracting beams for forming damage regions in Equation (1), below:

$${Z}_{R} > {F}_{D} ( π {{w}^{2}}_{0 , eff} ) / λ \qquad ( 1 )$$

where F_{D} is a dimensionless divergence factor having a value of at least 10, at least 50, at least 100, at least 250, at least 500, at least 1000, in the range from 10 to 2000, in the range from 50 to 1500, in the range from 100 to 1000. For a non-diffracting or quasi-non-diffracting beam, the distance, Z_{R} in Equation (1) over which the effective beam size doubles, is F_{D} times the distance expected if a typical Gaussian beam profile were used. The dimensionless divergence factor F_{D} provides a criterion for determining whether or not a laser beam is quasi-non-diffracting. As used herein, the pulsed laser beam 122 is considered quasi-non-diffracting if the characteristics of the laser beam satisfy Equation (1) with a value of F_{D}≥10. As the value of F_{D} increases, the pulsed laser beam 122 approaches a more nearly perfectly non-diffracting state.

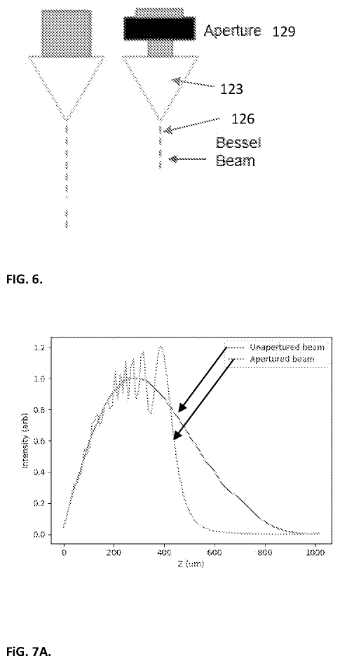

FIG. 6. illustrates of how an aperture 129 in a path of the input beam 122 situated before the axicon lens helps to sharply cut off the fading-out beam and reduces the length of the focal line formed by the resultant non-diffracting or a quasi-non-diffracting beam 122a, 122C.

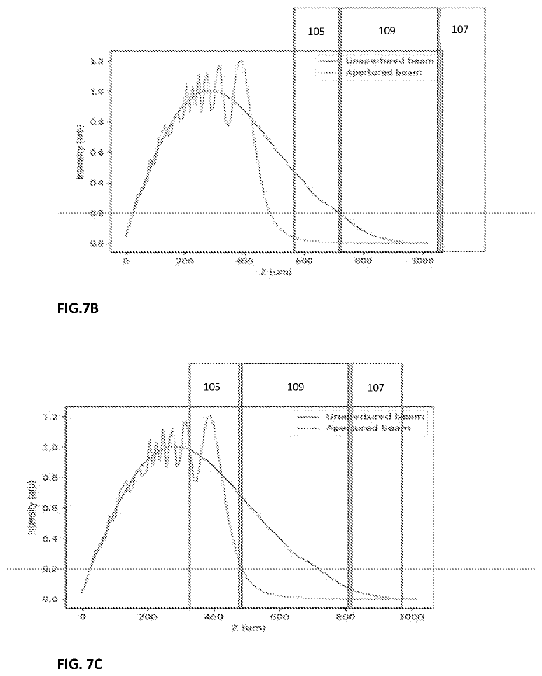

For example, as shown in FIG. 6 (right side), an optical system can utilize an apertured Gaussian laser beam 122 to form a Bessel beam scanned over an area of the laminate 100 at a specified pitch. This creates a shortened focal line 126 when the Bessel beam (or another non-diffracting beam) 122a, 122C is formed by the optical system of FIG. 3A. By contrast, as shown on the left side of FIG. 6, the unapertured Gaussian laser beam incident on the optical system containing an axicon creates a Bessel beam with a much longer focal line. The importance of the aperture 129 is to contain the damage only in the clad layer of the glass laminate 100, rather than letting it “fade” into the core layer 109 of the glass laminate 100. This damage to the core layer 109 of the glass laminate substrate can occur, for example, due to the high distribution of the axial intensity of a Bessel beam formed through an axicon with a normal (unapertured) Gaussian beam incident on the axicon. However, as shown in FIG. 7A, with the use of the optical aperture 129, the beginning of the Bessel beam's intensity sharply rises and the other end of the Bessel beam's intensity fades out (drops) much faster than that of a typical Bessel beam. For this reason, although the top (high intensity) portion of the Bessel beam may be utilized with or without an aperture to form LDRs 110 within the clad layers 105, 107, using the aperture 129 is much more preferable. That is, FIG. 7A illustrates the axial intensity of unapertured and apertured Bessel beams along their focal tracts (i.e., along beam propagation direction Z). It illustrates that the slope of the beam intensity falls more slowly in the unapertured beam causing the “fading out” effect. The aperture 129 may be either a hard aperture e.g., a diaphragm) or a soft aperture. Most optical apertures are hard apertures, which means that at any location they are either fully transmissive or fully block light. However, there are also soft apertures, exhibiting a gradual spatial variation of transmissivity realized with special dielectric coatings, for example.

Accordingly, it is preferable to irradiate the glass laminate substrate 100 with a quasi-non-diffracting beam having a beam path and a beam intensity along the beam path in the direction of beam propagation (Z) in the first clad layer and the core layer, such that beam intensity remains within a range of from 40 to 100 percent of maximum in the first clad layer (other than within a distance from the core layer 109 in the range of from 0 μm to 50 μm), and remains to within a range of from 40 to 0.1 percent of maximum (low intensity portion) within the core layer 109. Preferably, irradiating the glass laminate substrate 100 with a focused pulsed laser beam in the clad layer is done to a depth not more than the first clad layer thickness and/or within 0.1 μm to 20 μm distance from the core layer. It may be even more preferable to irradiate the glass laminate substrate 100 with a quasi-non-diffracting beam having a beam path and a beam intensity along a beam path in the direction of beam propagation in the first clad layer and the core layer, such that beam intensity remains within a range of from 30 to 100 percent of maximum in the first clad layer (other than within a distance from the core layer 109 in the range of from 0 μm to 50 μm), and remains to within a range of from 30 to 0.1 percent of maximum (low intensity portion) within the core layer 109. According to some embodiments the glass laminate substrate 100 is irradiated with a quasi-non-diffracting beam having a beam path and a beam intensity along the beam path in the direction of beam propagation in the first clad layer and the core layer, such that beam intensity remains within a range of from 20 to 100 percent of maximum in the first clad layer (other than within a distance from the core layer 109 in the range of from 0 μm to 50 μm), and remains to within a range of from 20 to 0.1 percent of maximum (low intensity portion) within the core layer 109. According to some embodiments the glass laminate substrate 100 is irradiated with a quasi-non-diffracting beam having a beam path and a beam intensity along a beam path in a direction of beam propagation in the first clad layer and the core layer, such that beam intensity remains within a range of from 40 to 100 percent of maximum intensity in at least 75% (e.g., at least 80% or less) of the thickness of the first clad layer, and remains to within a range of from 20 to 0.1 percent of maximum intensity (low intensity portion) within the core layer 109.

FIG. 7B illustrates a correct exemplary placement of the glass laminate substrate relative to the non-apertured gaussian-Bessel beam. For example, if intensity below 0.2 (i.e., 20 percent) of the maximum intensity was required to avoid damaging the core layer 109, the placement of glass laminate substrate 100 relative to the cross-section of the laser focal line (or its intensity distribution) should be as shown in FIG. 7B. However, when the glass laminate substrate 100 is placed in such manner relative to the non-apertured gaussian-Bessel beam, the cladding layer 105 does not receive the highest laser intensity provided by such beam. It receives only about half or less of the beam energy, which is undesirable.

FIG. 7C illustrates a correct exemplary placement of the glass laminate substrate 100 relative to the apertured gaussian-Bessel beam. More specifically, if a laser beam intensity below 0.2 (i.e., 20 percent) of the maximum intensity was required to avoid damaging the core layer 109, the placement of glass laminate substrate 100 relative to the cross-section of the laser focal line (or its intensity distribution) should be as shown in FIG. 7C. As one can see, in this exemplary embodiment, the laser beam intensity in the core layer 109 of the glass laminate substrate 100 drops faster than that shown in FIG. 7C. Thus, with this placement the core 109 receives less energy (less intensity) from the apertured optical system than from the optical system that does not utilize the aperture, which advantageously results in smoother recess bottoms 140b and formation of a fewer number of undesirable micro-cracks in the core layer 109 due to the laser damage. Also, higher intensity is available to the clad layer 105, advantageously resulting in faster formation of LDRs 110 within the clad layer.

The optical system 120 may be optimized to form a quasi-non-diffracting beam 122C that produces a focal line 126 such that very little or none of the focal line 126 extends below the interface between the core layer and the clad layer(s) of the glass laminate substrate 100. This may be achieved by using optics that create sharp cut-offs in the beam intensity along the optical axis. Alternatively, the cut-off may be accomplished by positioning a hard aperture such as an iris in the beam path in front of the axicon 123 as shown in FIG. 6. The aperture may also be a soft aperture. By vignetting the outermost rays in the input pulsed laser beam 122, the tail (i.e., end) of the focal line 126 will be cut off, creating a sharp cut-off at the tail of the focal line 126.

Regardless of the method used to generate the sharp cut-off in the tail of the focal line 126, if the tail of the focal line is made to extend just barely beyond the core/clad interface (e.g., 25 μm or less, 10 μm or less, 5 μm or less, or 1 μm or less), then very little energy is left to cause unwanted damage to the glass laminate substrate In some embodiments, precise focus control of the focal line 126 should be made with respect to the positioning of the glass laminate substrate 100.

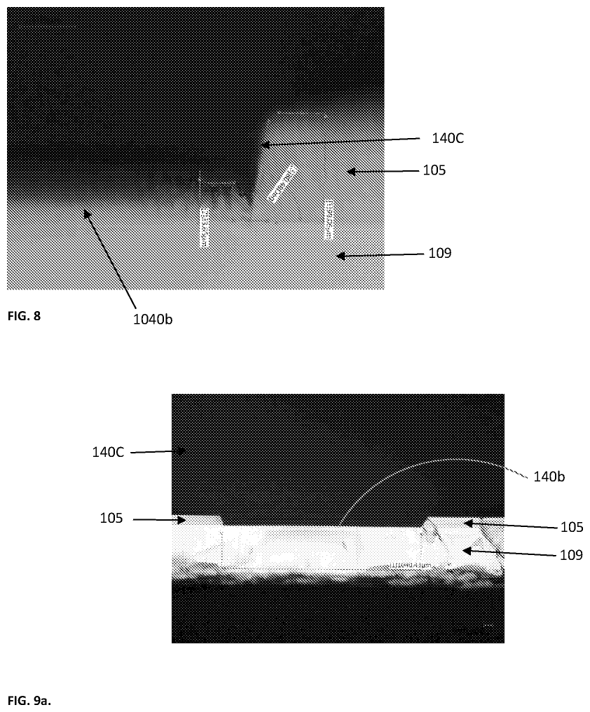

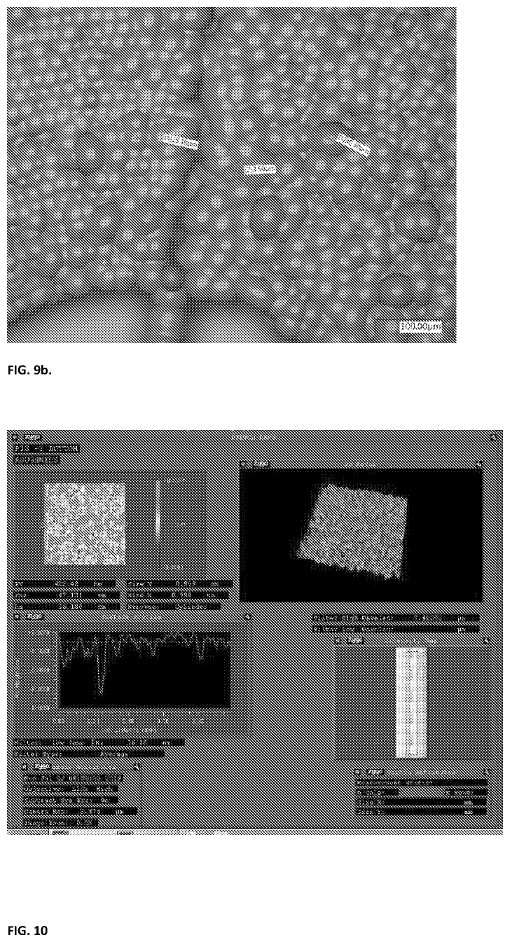

Compared to the bulk of the glass, the etch ratio of the damage region is two or more times faster than in the core layer, depending on the laser parameters used. After laser damage, the substrate is exposed to dissolution chemicals and the different etch ratios between the clad, damaged clad, and the core are used to create the desired recess. Compared to the undamaged region of the clad, the damaged region etches faster and reaches down to the core first. This is illustrated in FIG. 8, which depicts the LDR (left side of the figure) etched down within the cladding layer. The right side of this figure depicts the undamaged (unetched) cladding material. More specifically, the left side of the cladding was laser damaged and had a faster etch rate than the rest (right side) of the cladding. Therefore, the LDR was etched all the way to the core layer 109 (i.e., to the etch stop layer, while the rest of the cladding material surrounds the resultant recess (etched out LDR). FIG. 8 also illustrates that the minimal clad material in the bottom of the recess is etched away, exposing the smooth core layer 109 under the laser-damaged region LDR. Around this laser-damaged region the unetched bulk of the clad 105 is still 5 μm to 300 μm (or more) higher than the newly exposed core layer 109 at the bottom of the recess 140. This allows for the etch stop effect of the core 109 to form a smooth recess bottom while still having undamaged cladding material around the recess, as shown in FIG. 9A, without having the negative effects (rough bottom in resultant cavities) of laser-enhanced etching in non-laminate glasses (shown in FIG. 9B). More specifically, FIG. 9B depicts roughness at the bottom of a recess created in a comparative homogeneous, non-laminate glass and illustrates the benefits of forming recesses in a glass-based laminate.

According to some embodiments, the smooth bottom 140b of recess 140 may advantageously have an RMS surface roughness of <75 nm, less than 60b nm, or not greater than 50 nm.

According to some embodiments, the smooth bottom 140b of recess 140 may advantageously have a RMS surface roughness of <50 nm (as shown in FIG. 10), which we believe is achievable only by using glass-based laminates 100 (e. g., glass laminates). More specifically, FIG. 10 depicts roughness measurement of the recess of FIG. 9a, performed with a Zygo

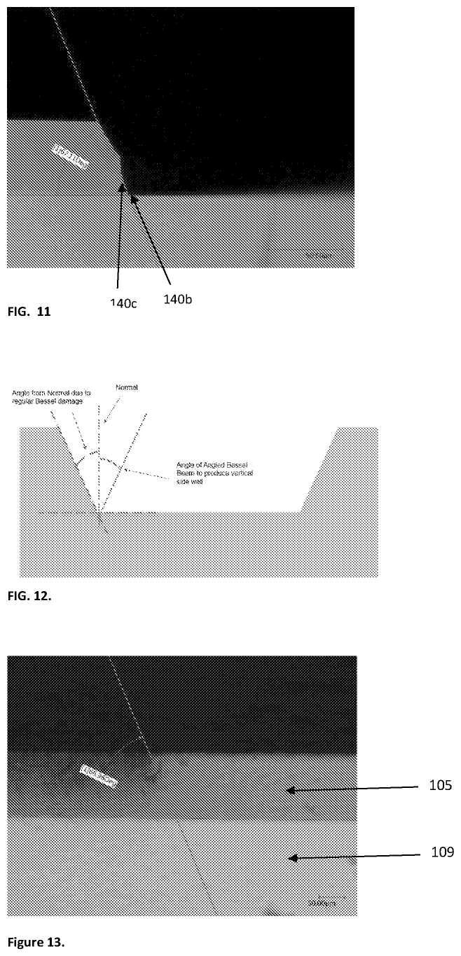

After the Bessel beam damage is etched out with specific chemistry, the recess sidewall's tilt angle can be measured as shown in FIG. 11. More specifically, FIG. 11 illustrates the recess 140 with angled sidewalls. This recess 140 with angled sidewalls 140c is produced after etching an LDR formed with vertical sidewalls, and has the angled sidewalls because the top portion of the recess sidewall(s) 140c was exposed to etchant for a longer time than the bottom portion of the sidewall. More specifically, because FIG. 11 depicts a sidewall's angle created by a normal (90 degree angle to the laminate) Bessel Beam followed by etching, after the etching the resultant sidewall angle(s) can be used to predict the required incident angle of angled Bessel beam will that after a similar etching step, resulting a recess with vertical side wall(s), or in sidewalls of any desired angle. FIG. 12 illustrates schematically an LDR with an angled sidewall produced by a normal (Bessel beam). Then, the incident angle (relative to the normal to the laminate substrate 100) of the angled Bessel beam was chosen to compliment the angle measured in FIG. 11. The LDR formed by the angled Bessel beam can then be exposed to etching conditions used to a recess 140 with a vertical sidewall 140c.

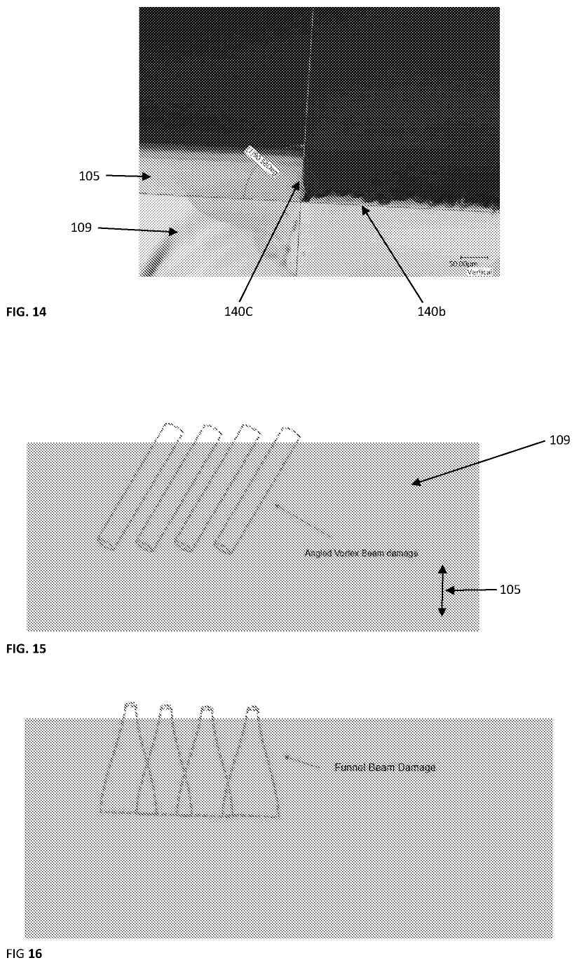

That is, under the same etching conditions, an angled Bessel beam of the same angle but opposite sign (opposite direction from the normal as shown in FIG. 12) can utilized to form laser-damaged area(s), as shown, for example, in FIG. 13. This damaged laser area(s) will then etch out to create at least one recess 140 with the predetermined sidewall angle (e. g., with the perpendicular sidewalls 140c shown in FIG. 14). It is noted that because the color layer 109 acts as an “etch stop”, with a little more etch time some or all of the reminder of the cladding material on the bottom of the recess 140 shown in FIG. 14 will etch out, forming smooth bottom 140b at the core layer interface.

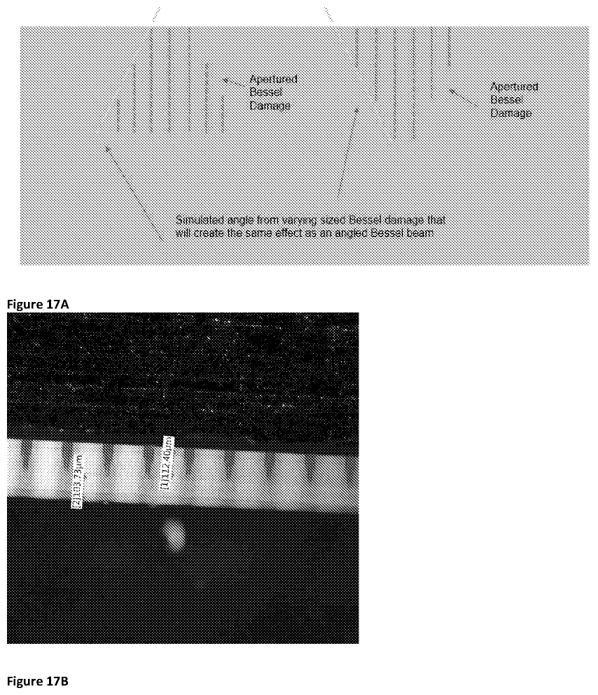

Not only can Bessel or Angled Bessel beam damage be utilized to form recesses 140, but to further enhance etching rates, Vortex beams, Funnel beams, and Vari-rad beams may also be used in a similar manner. For example, by damaging a cladding region of the laminate substrate 100 with a Vortex beam and then etching the LDRs, a wall angle specific to that beam angle and etching chemistry can create the same effect that the Bessel beam does. An angled Vortex beam or a Funnel beam with a correct increasing radii can be used to create a recess 140 with the desired sidewall angle after etching. For example, FIG. 15 illustrates laser damage in glass formed by an angled Vortex laser beam has a shape of angled hollow cylinder(s) that can have radii of curvature that depend on the order of the vortex plate used to create the Vortex beam(s). Also for example, FIG. 16 illustrates damage in glass due to use of a Funnel laser beam. The incident angle of the Funnel beam on the laminate substrate 100 can also be used to induce the desired side wall angle(s) 140C.

Another way of simulating an angle on the periphery of laser induced damage to create a preferred sidewall angle is to use varying apertured non-diffracting beams to create a damage angle (FIGS. 17A and 17B). The damage of increasing or decreasing size will connect to the features next to them during the etching process. This will create the same effect as an angled Bessel beam, without tilting the sample or the incoming beam. The varying apertured Bessel beams can decrease production time and allow for more complicated recess shapes to be created with more ease. These beams can also be combined with a variety of etching masks that allow for the bulk of the undamaged glass to not become subject to dissolution while the laser-damaged areas are. This can add advantages such as thicker channels and different side wall geometry.

The etching conditions that can be used for the etching step(s) described herein n include wet etching baths with or without agitation, ultrasonics, and spray, to achieve different rates and angles of side walls. With these conditions the etching chemistry may range from 0.1 wt % HF to 20 wt % HF, 0.1 wt % HCl to 20 wt % HCl, 0.1 wt % KOH to 20 wt % KOH, 0.1 wt % NaOH to 20% NaOH, and 0.1 wt % Nitric to 20 wt % Nitric with temperatures of the solution ranging from −20° C. to 90° C. Glass compositions that can be utilized as layers in the glass laminate substrate(s) include, for example, fused silica, boro-aluminosilicates, aluminosilicates, as well as glasses containing at least one of: lithium/magnesium, calcium, phosphorus.

While a wet etching process is described above, photomachining may also provide a suitable process for forming the recess 140 within the upper glass clad layer 105 and/or the lower glass clad layer. For example, an energy source, such as a laser, a ultraviolet radiation source, or the like, may be incident on portions of the glass substrate 100 and may form cracks and/or crystallize exposed portions of the glass substrate 100 that are photosensitive to the energy source. The crystallized/cracked portions of the glass laminate substrate 100 may then have a comparatively high etch rate in an etchant and may be removed by exposing the laminate glass substrate to an etchant.

The embodiments of the process for making recesses described herein provide at least one of the following advantages:

Control over geometry of the sidewalls 140c—The geometry of the sidewalls can be controlled by changing the shape of the LDR.
Varied sidewall geometry within a single recess—Ability to vary the geometry of different side walls in the same cavity or channel by altering the laser beam used to create the LDR.
Increased etch rate—The etch rate of the LDR will be increased due to laser damage which lowers etching cost.
Eliminating the need for masking—While this process can be combined with masking to prevent damage to unmodified glass surfaces, no masking is required to create the cavities.
Varied recess depth within a workpiece—In addition to varying sidewall angles, multiple cavities with different depths can be created in a single workpiece.

Faster processing (nondiffracting beam)—Non-diffracting beam damage using an ultrafast laser requires only one shot to damage the entire thickness of the cavity. This means that the beam can be scanned in only the X and Y directions to create a 3D cavity (a Gaussian focus would require a 3D scan in the X, Y, and Z directions to create the same LDR).

Faster processing (high pitch)—Using a burst-mode laser, the radius of laser damage from a single shot can be greatly expanded. While the Bessel beam focal spot is a narrow cylinder (˜0.4-1 μm radius by ˜1 mm length), cracking from an intense laser shot with burst can extend 20 μm or more from the central damage area. This allows a high pitch between shots to be used during processing, increasing speed.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

1. A method of forming recesses in a glass laminate, the method comprising:
irradiating a portion of a first clad layer of a glass laminate with a pulsed laser beam, the glass laminate comprising the first clad layer having a first clad layer thickness and a first clad layer external surface and a core layer having a core layer thickness, the irradiating producing an irradiated portion of the first clad layer and a non-irradiated portion of the first clad layer; and
etching the first clad layer with an etchant that selectively etches the irradiated portion of the first clad layer relative to the non-irradiated portion of the first clad layer and selectively etches the irradiated portion of the first clad layer relative to the core layer,
wherein irradiating with a pulsed laser beam is one of:
(1) irradiating with a focused pulsed laser beam producing damage or other physical or chemical alteration in the first clad layer to a depth not more than the first clad layer thickness and within 0.1 to 20 μm distance from the core layer, and
(2) irradiating with a quasi-non-diffracting beam having a beam path and a beam intensity along a beam path in a direction of beam propagation in the first clad layer and the core layer which intensity remains within a range of from 40 to 100 percent of maximum in the first clad layer other than within a distance from the core layer in the range of from 0 to 50 μm, and remains to within a range of from 40 to 0.1 percent of maximum (low intensity portion) within the core layer.

2. The method of claim 1 wherein the etchant selectively etches the non-irradiated portion of the first clad layer relative to the core layer with selectivity ratio within the range of from 2:1 to 100:1.

3. The method of claim 1 wherein an area of a cross section of the irradiated portion, taken parallel to the first clad layer external surface beginning just inside the first clad layer external surface and progressed toward the core layer, increases at at least some location along the progression.

4. The method of claim 1, wherein during irradiation the pulsed laser beam is positioned relative to the glass laminate to propagate within the first clad layer at an angle with the range of from 5 to 45 degrees of normal to a surface of the first clad layer.

5. The method of claim 4 wherein the pulsed laser beam is a quasi-non-diffracting beam which is aberration-corrected for non-aberrated quasi-non-diffracting propagation within the first clad layer at the angle with the range of from 5 to 45 degrees of normal to the surface of the first clad layer.

6. The method of claim 1, wherein the pulsed laser beam is a quasi-non-diffracting beam and wherein the radial energy distribution of the pulsed laser beam, while in Gaussian propagation, is limited by an aperture with an aperture radius corresponding to a beam intensity within a range of from 10 to 70 percent of peak beam intensity.

7. The method of claim 6 wherein the aperture is a soft aperture.

8. The method of claim 1 wherein the pulsed laser beam is a quasi-non-diffracting beam and wherein irradiating with a pulsed laser beam comprises propagating the quasi-non-diffracting beam in the first clad layer in a direction toward the core layer.

9. The method of claim 1 wherein the pulsed laser beam is a quasi-non-diffracting beam and wherein irradiating with a pulsed laser beam comprises propagating the quasi-non-diffracting beam in the first clad layer in a direction away from the core layer.

10. The method of claim 1 wherein the glass laminate comprises a second clad layer opposite the first clad layer with the core layer between the first clad layer and the second clad layer, and wherein the method comprises irradiating a portion of the second clad layer and etching the second clad layer.

11. The method of claim 1 wherein the pulsed laser beam is a quasi-non-diffracting beam having a focal spot and/or focal ring width along the beam path in a direction of beam propagation which increases by an increase in the range of from 1 to 400 percent per 100 μm distance in the downstream direction.

12. The method of claim 1 wherein the pulsed laser beam is a quasi-non-diffracting beam having a focal spot and/or focal ring width along the beam path in a direction of beam propagation which decreases by in the range of from 1 to 80 percent per 100 μm distance in the downstream direction.

13. The method of claim 1 wherein the pulsed laser beam is a quasi-non-diffracting beam and wherein the beam path of the quasi-non-diffracting beam is curved at least in part.

14. The method of claim 1 wherein the pulsed laser beam is an annular quasi-non-diffracting beam.

15. The method of claim 14 wherein the pulsed laser beam is an annular quasi-non-diffracting beam having a varying radius.

16. The method of claim 1 wherein the pulsed laser beam is an airy beam.

17. The method of claim 1 wherein the pulsed laser beam is a quasi-non-diffracting beam and wherein the average width of the quasi-non-diffracting beam within the first clad layer is in the range of from 50 to 300 μm.

18. The method of any of claim 1 wherein the pulsed laser beam is a quasi-non-diffracting beam transmitted or formed at least in part by an adaptive optical element.

19. The method of claim 18 wherein irradiating a portion of a first clad layer of a glass laminate with a pulsed laser beam comprises varying the properties of the adaptive optical element to vary one or more properties of the quasi-non-diffracting beam.

20. A glass-based laminate comprising:
(i) a glass-based core layer; and
(iii) at least one cladding situated directly adjacent to the core layer, the at least one clad layer comprising at least one recess with at least one vertical sidewall and a smooth bottom with RMS surface roughness<75 nm.
